(19) United States
(12) Patent Application Publication
(10) Pub. No.: US 2026/0226943 A1
(43) Pub. Date: Aug. 6, 2026

(54) LOW-WEIGHT HYDRODYNAMIC THRUST BEARING PAD AND RELATED METHODS

(71) Applicant: Ohio University, Athens, OH (US)

(72) Inventors: Muhammad Ali, Pickerington, OH (US); Collier Fais, Arvada, CO (US); Isaiah Yasko, The Plains, OH (US); Khairul Alam, Athens, OH (US)

(21) Appl. No.: 19/152,412

(22) PCT Filed: Jan. 31, 2024
(86) PCT No.: PCT/US2024/013747

§ 371 Date: Jul. 30, 2025

Related U.S. Application Data
(60) Provisional application No. 63/482,705, filed on Feb. 1, 2023.

(51) Int. Cl. F16C 32/06

(52) U.S. Cl. CPC F16C 32/0659; F16C 2210/04

(57) ABSTRACT

A hydrodynamic thrust bearing pad for use with a hydrodynamic thrust bearing assembly is disclosed. The hydrodynamic thrust bearing pad includes a bearing body with a bearing surface and an opposite base surface. The bearing surface is configured to confront a thrust flange of the hydrodynamic thrust bearing assembly and the base surface is configured to confront a stationary disc of the hydrodynamic thrust bearing assembly. The hydrodynamic thrust bearing pad includes at least one weight-reducing void formed in the bearing body.

### CROSS-REFERENCE TO RELATED APPLICATION

The present application claims the filing benefit of U.S. Provisional Application Ser. No. 63/482,705, filed Feb. 1, 2023, the disclosure of which is incorporated herein by reference in its entirety.

### TECHNICAL FIELD

The invention relates generally to thrust bearings and, more particularly, to hydrodynamic thrust bearing pads.

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Bearings are well-known mechanical devices that handle load and, in parallel, reduce friction between moving components. Such reduction in friction allows a bearing to aid a system in either rotational or linear movement. Hydrodynamic thrust bearings are a particular type of bearing that support thrust or axial load by forcing a dynamic lubricant through converging surfaces in relative motion to reduce friction due to such relative motion among mechanical components/assembly.

In particular, conventional hydrodynamic thrust bearings are configured to hydraulically transmit axial thrust loads from a shaft to an adjacent stationary support structure. A hydrodynamic thrust bearing assembly typically includes a propulsion shaft having a radial thrust flange secured thereto; a housing enclosing and supporting the shaft with a stationary housing member axially spaced apart from the thrust flange; and a plurality of bearing pads disposed between the rotating thrust flange and the stationary housing member for transmitting thrust loads therebetween. A hydrodynamic lubricant film is maintained between the rotating thrust flange and the bearing surface of the bearing pads to allow the thrust flange to rotate freely, in spaced relationship, over the bearing surfaces and effectively transmit thrust loads thereto through the lubricating film.

Bearing pads are typically machined or otherwise formed of a solid material, such as a block of stainless steel or ceramic, for example. In that regard, oil is introduced through grooves provided between the stationary bearing pads and flows between the bearing surfaces of the pads and the opposing surface of the rotating thrust flange to form an oil film. In order to facilitate flow of the oil between the bearing surfaces of the pads and the rotating thrust flange, a permanent taper contour is typically cut, machined, or otherwise pre-formed along an edge of each bearing pad to provide a gap therebetween for the oil to flow through. However, these types of machined bearing pads are typically formed as a solid geometric shape (e.g., square, rectangle, trapezoidal, etc.) that can be undesirably heavy for certain applications as well as expensive to machine. Further, once the bearing pads have been machined or otherwise formed, they cannot be easily reshaped to reduce friction or facilitate the introduction of lubricating oil between the moving surfaces in the bearing, for example, especially during in-cycle operation of the bearing.

Therefore, it would be desirable to provide an improved hydrodynamic thrust bearing pad that is lighter in weight and which allows the configuration of the bearing pad to be changed during operation of the bearing to reduce wear and related friction, as well as facilitate the flow of lubricating oil between the moving surfaces of the bearing to maintain an effective oil film therebetween.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

The present invention overcomes the foregoing and other shortcomings and drawbacks of hydrodynamic thrust bearing pads. While the present invention will be discussed in connection with certain embodiments, it will be understood that the present invention is not limited to the specific embodiments described herein.

More specifically, embodiments of the present invention are directed to a bearing pad, and methods of forming a bearing pad, for a hydrodynamic thrust bearing. In particular, the bearing pad may be formed using additive manufacturing processes to provide the bearing pad with a light-weight, organic-shaped structure capable of withstanding the loads imposed during in-cycle operation of the hydrodynamic thrust bearing. As will be described in further detail below, additive manufacturing methods provide the unique benefit of fabricating a thrust bearing pad with material removed where strength is not needed to thereby form the thrust bearing pad having weight-saving voids. The weight-saving voids may be formed in the body of the bearing pad or on one side of the bearing pad to collectively define surfaces that are organic in shape. In either case, the result is a light-weight bearing pad with performance capabilities comparable to a conventional geometrically-shaped, solid-body thrust pad.

According to one embodiment of the invention, a hydrodynamic thrust bearing pad for use with a hydrodynamic thrust bearing assembly is provided. The hydrodynamic thrust bearing pad includes a bearing body having a bearing surface and an opposite base surface. The bearing surface is configured to confront a thrust flange of the hydrodynamic thrust bearing assembly and the base surface is configured to confront a stationary disc of the hydrodynamic thrust bearing assembly. The hydrodynamic thrust bearing pad further includes at least one weight-reducing void formed in the bearing body.

According to one aspect of the invention, the at least one weight-reducing void of the hydrodynamic thrust bearing pad may include a plurality of voids that extend into the body from the base surface. For example, the plurality of voids may extend into the body from a first sidewall and a second sidewall of the body. Additionally or alternatively, the plurality of voids may be embedded within the body of the hydrodynamic thrust bearing pad. In yet another aspect, the plurality of voids may define an organic-shaped surface. The organic-shaped surface may undulate in accordance with one aspect. In yet another aspect, the plurality of voids may jointly form a cavity in the bearing body. The cavity may be an external cavity or an internal cavity.

According to another aspect of the invention, the at least one weight-reducing void may define a hollow interior of the bearing body. In one aspect, the hollow interior may include a network of webbing structures. For example, the network of webbing structures may comprise a plurality of interconnected web members. In yet another aspect, the network of webbing structures may be configured to temporarily deform when subjected to heat to form a contour along the bearing surface of the bearing body. For example, the network of webbing structures may thermally expand to form the contour along the bearing surface of the bearing body. Furthermore, the contour may be a gradual taper along the bearing surface of the bearing body.

According to yet another aspect of the invention, the at least one weight-reducing void is a deflection gap that extends beneath a center region of the bearing surface of the bearing body. For instance, the deflection gap may extend a length from a first opening formed in a first radially inner surface of the bearing body to a second opening formed in a radially outer surface of the bearing body. Further, the deflection gap may include an arcuate top wall that is curved in a direction generally perpendicular to the length of the deflection gap.

According to one aspect of the invention, a hydrodynamic thrust bearing assembly is provided. The hydrodynamic thrust bearing assembly includes a rotatable shaft, a thrust surface fixedly coupled to the rotatable shaft for rotation therewith, and a stationary surface spaced apart from the thrust surface. The hydrodynamic thrust bearing assembly further includes one or more hydrodynamic thrust bearing pads according to any one of the embodiments described above.

According to another aspect of the invention, a method of forming a hydrodynamic thrust bearing pad for use with a hydrodynamic thrust bearing assembly is provided. The method includes providing a computer model design of a first hydrodynamic thrust bearing pad design in a modeling software. The method further includes generating a pressure map across a bearing surface of the first hydrodynamic thrust bearing pad design, applying the pressure map to the first hydrodynamic thrust bearing pad design in the modeling software, and optimizing the first hydrodynamic thrust bearing pad design by changing a part of the body of the first hydrodynamic thrust bearing pad design to create a second hydrodynamic thrust bearing pad design in the modeling software. The method further includes forming the hydrodynamic thrust bearing pad based on the second hydrodynamic thrust bearing pad design.

According to another aspect of the invention, the pressure map may be generated based on a database of experimental thrust bearing performance data.

According to yet another aspect, changing a part of the body of the first hydrodynamic thrust bearing pad design may comprise removing material from the body. In one aspect, optimizing the first hydrodynamic thrust bearing pad design is based on maintaining a structural stiffness of the hydrodynamic thrust bearing pad. In another aspect, the method further includes forming the hydrodynamic thrust bearing pad using additive manufacturing processes.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a partial perspective view of an exemplary hydrodynamic thrust bearing assembly in accordance with an aspect of the invention.

FIG. 1A is a top perspective view of a low-weight bearing pad for use with the with the hydrodynamic thrust bearing assembly of FIG. 1.

FIG. 1B is a bottom perspective view of the low-weight bearing pad of FIG. 1A, illustrating additional details of an external annular cavity.

FIG. 1C is a cross-sectional view of the low-weight bearing pad of FIGS. 1A and 1B, illustrating additional details of the external annular cavity and internal annular cavities.

FIG. 2 is a perspective view of a bearing pad for use with the hydrodynamic thrust bearing assembly of FIG. 1 in accordance with an aspect of the invention.

FIG. 2A is a cross-sectional view of the bearing pad taken along line 2A-2A of FIG. 2, illustrating details of weight-reducing voids formed in the bearing pad.

FIG. 3 is a perspective view of the bearing pad of FIG. 2, illustrating additional details of weight-reducing voids formed in the bearing pad.

FIG. 4 is a perspective view of the bearing pad of FIGS. 2-3, further illustrating details of the weight-reducing voids formed in the bearing pad.

FIG. 5 is a simplified schematic depiction of a body section of a bearing pad for use with the hydrodynamic thrust bearing assembly of FIG. 1 in accordance with another aspect of the invention.

FIG. 6 is a cross-sectional view of the body section of FIG. 5, illustrating details of a network of webbing structures integrated within the body section.

FIG. 7 is an enlarged view of a portion of the network of webbing structures of FIG. 6.

FIG. 8 is a top view, a side view, and a front view of the body section of FIGS. 5-6, illustrating a thermally-induced taper curvature over a bearing surface of the body section.

FIG. 9 is a graphic representation of characteristic pressure distribution profiles across a radial section of the bearing surface of a bearing pad.

FIG. 10 is a perspective view of an exemplary low-weight flex pad bearing (LWFPB) in accordance with an aspect of the invention.

FIG. 11 is a perspective view of a bearing pad section of the LWFPB of FIG. 10.

FIG. 12 is a front view of the bearing pad section FIG. 11.

FIG. 13 is a rear view of the bearing pad section FIGS. 11 and 12.

FIG. 14 is a perspective view of the bearing pad section FIGS. 11-13, illustrating a thermally-induced taper curvature over a bearing surface of the bearing pad section.

FIG. 15 is a rear view of the bearing pad of FIG. 14, further illustrating the thermally-induced taper curvature over the bearing surface.

FIGS. 16A-16D are graphic representations of pressure distribution development over the bearing surface of a cast bearing pad at various rotational speeds with a 30° C. inlet oil temperature.

FIGS. 17A-17D are graphic representations of pressure distribution development over the bearing surface of a Low Weight Alloy Bearing (LWAB) at various rotational speeds with a 30° C. inlet oil temperature.

FIGS. 18A-18D are graphic representations of pressure distribution development over the bearing surface of a cast bearing pad at various rotational speeds with a 40° C. inlet oil temperature.

FIGS. 19A-19D are graphic representations of pressure distribution development over the bearing surface of a LWAB bearing at various rotational speeds with a 40° C. inlet oil temperature.

FIGS. 20A-20D are graphic representations of pressure distribution development over the bearing surface of a cast bearing pad at various rotational speeds with a 50° C. inlet oil temperature.

FIGS. 21A-21D are graphic representations of pressure distribution development over the bearing surface of a LWAB bearing at various rotational speeds with a 50° C. inlet oil temperature.

FIG. 22A is a graphic representation comparing the minimum oil film thickness (MOFT) over the bearing surface of a cast bearing pad versus a LWAB bearing at various rotational speeds with a 30° C. inlet oil temperature.

FIG. 22B is a graphic representation comparing the minimum oil film thickness (MOFT) over the bearing surface of a cast bearing pad versus a LWAB bearing at various rotational speeds with a 40° C. inlet oil temperature.

FIG. 22C is a graphic representation comparing the minimum oil film thickness (MOFT) over the bearing surface of a cast bearing pad versus a LWAB bearing at various rotational speeds with a 50° C. inlet oil temperature.

FIG. 22D is a graphic representation comparing the bearing operating temperatures of a cast bearing pad versus a LWAB bearing at various rotational speeds with a 30° C. inlet oil temperature.

FIG. 22E is a graphic representation comparing the bearing operating temperatures of a cast bearing pad versus a LWAB bearing at various rotational speeds with a 40° C. inlet oil temperature.

FIG. 22F is a graphic representation comparing the bearing operating temperatures of a cast bearing pad versus a LWAB bearing at various rotational speeds with a 50° C. inlet oil temperature.

FIG. 22G is a graphic representation comparing the oil temperature increase of a cast bearing pad versus a LWAB bearing at various rotational speeds with a 30° C. inlet oil temperature.

FIG. 22H is a graphic representation comparing the oil temperature increase of a cast bearing pad versus a LWAB bearing at various rotational speeds with a 40° C. inlet oil temperature.

FIG. 22I is a graphic representation comparing the oil temperature increase of a cast bearing pad versus a LWAB bearing at various rotational speeds with a 50° C. inlet oil temperature.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention are directed to a bearing pad, and methods of forming a bearing pad, for a hydrodynamic thrust bearing. In particular, the bearing pad may be formed using additive manufacturing processes to provide the bearing pad with a light-weight, organic-shaped structure capable of withstanding the loads imposed during in-cycle operation of the hydrodynamic thrust bearing. As will be described in further detail below, additive manufacturing provides the unique benefit of fabricating a thrust bearing pad with material removed where strength is not needed to thereby form the thrust bearing pad having weight-saving voids that collectively define surfaces of the bearing pad, both internally and externally, that are organic in shape (i.e., an organic-shaped surface). The result is a light-weight bearing pad with performance capabilities comparable to a conventional geometrically-shaped, solid-body thrust pad.

By “organic in shape,” it is meant that specific surfaces of the bearing pad exhibit a free-form or curvilinear appearance. In other words, these surfaces possess a natural, flowing, and/or curving appearance akin to surfaces observed in nature, such as those found on a rock, for instance. This definition emphasizes the notion that certain bearing pad surfaces are not angular or symmetrical but rather emulate the organic and fluid shapes observed in natural elements as a result of the iterative design process that provides suggestions where material may be removed to save weight while maintaining sufficient structural stiffness of the bearing. The bearing pad of the present invention may also be formed with internal structures, specifically located within voids formed in the bearing pad, that are designed to deform when subject to thermal stress to induce an oil film promoting taper, particularly during in-cycle operation of the bearing. These and other aspects of the present invention will be described in further detail below.

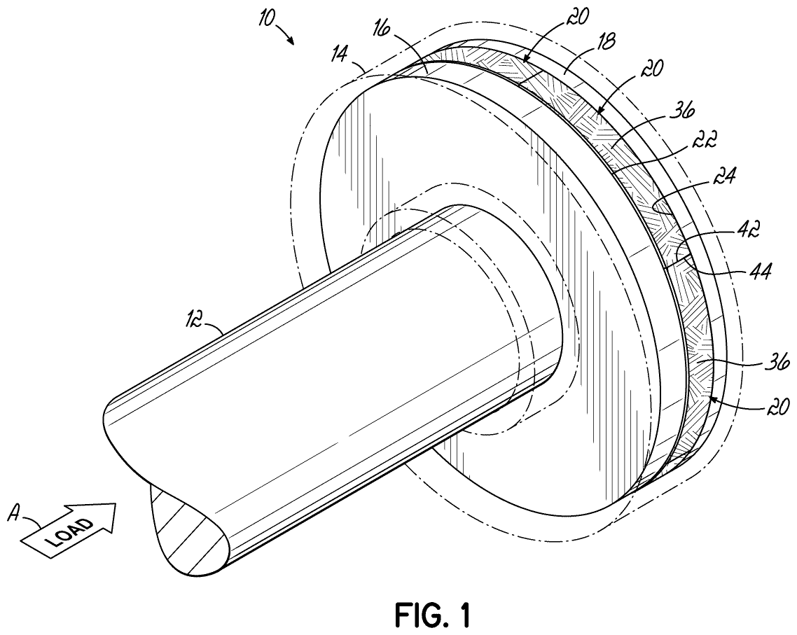

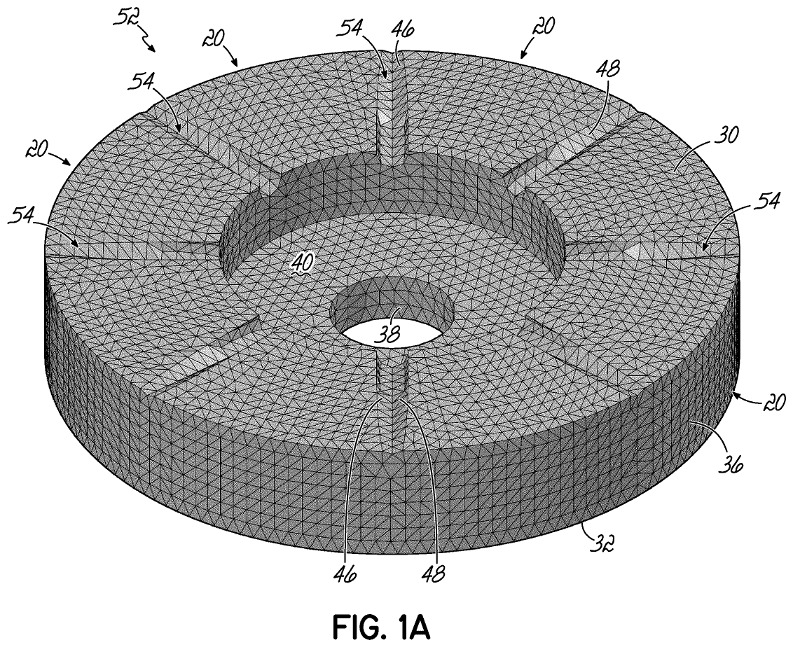

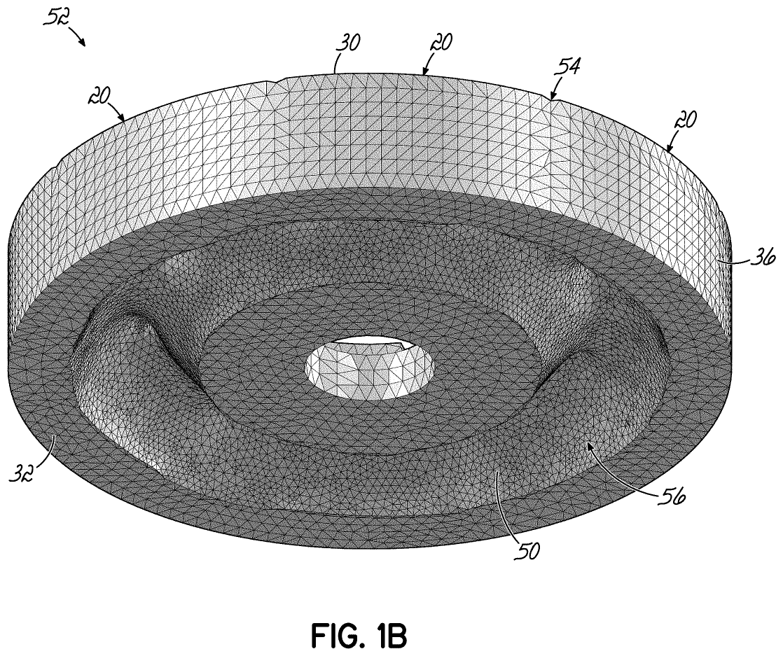

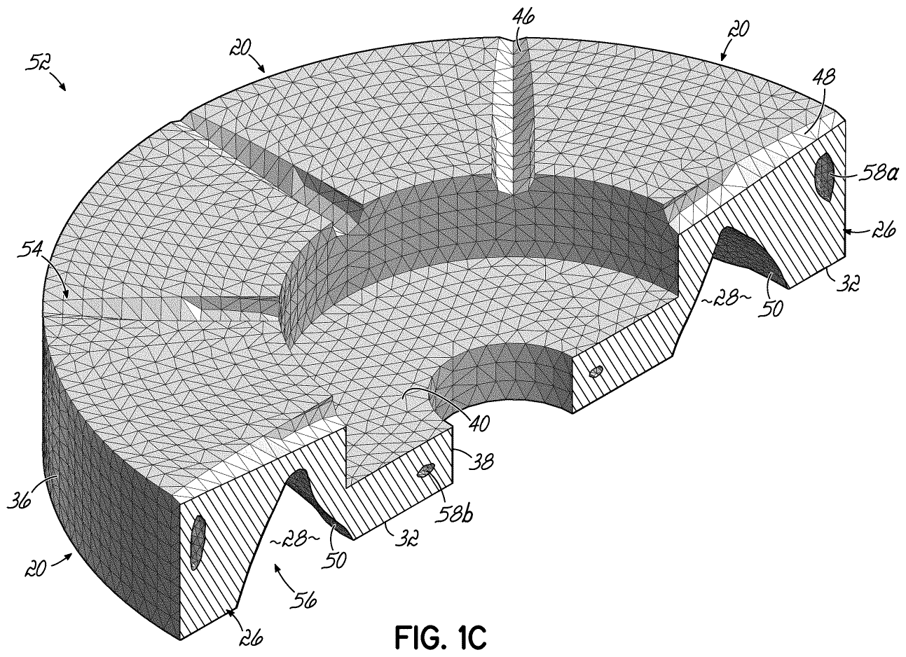

Referring now to FIG. 1, an exemplary hydrodynamic thrust bearing assembly 10 is shown. The illustrated assembly 10 includes a propulsion shaft 12 rotatably supported and at least partially enclosed by a stationary housing 14. A radial thrust flange 16 is fixedly coupled to the propulsion shaft 12 for rotation therewith, and is axially spaced apart from a stationary support or disc 18 fixedly coupled to the stationary housing 14. As shown, a plurality of circumferentially-spaced bearing pad sections 20 are disposed between the rotating thrust flange 16 and the stationary disc 18 for transmitting thrust loads therebetween, as indicated by the arrow A. The bearing pad sections 20 may be replaced with a single bearing pad. In either case, the thrust flange 16 includes a planar thrust surface 22 and the illustrated stationary disc 18 includes an opposing planar stationary surface 24 spaced apart from each other to receive the bearing pad sections 20 and lubricant therebetween. A hydrodynamic lubricant film is maintained between the rotating thrust flange 16 and the bearing pad sections 20 to allow the thrust flange 16 to rotate freely, in spaced relationship, over the bearing pad sections 20 and effectively transmit thrust loads thereto through the lubricating film. As described in greater detail below, the bearing pad sections 20 may include weight-reducing voids and/or are configured to at least partially deform or warp at certain temperature loads to assume one or more predetermined profiles to facilitate entry of the lubricating oil between the bearing pad sections 20 and the thrust flange 16 in a controlled and adjustable manner to maintain an effective oil film therebetween.

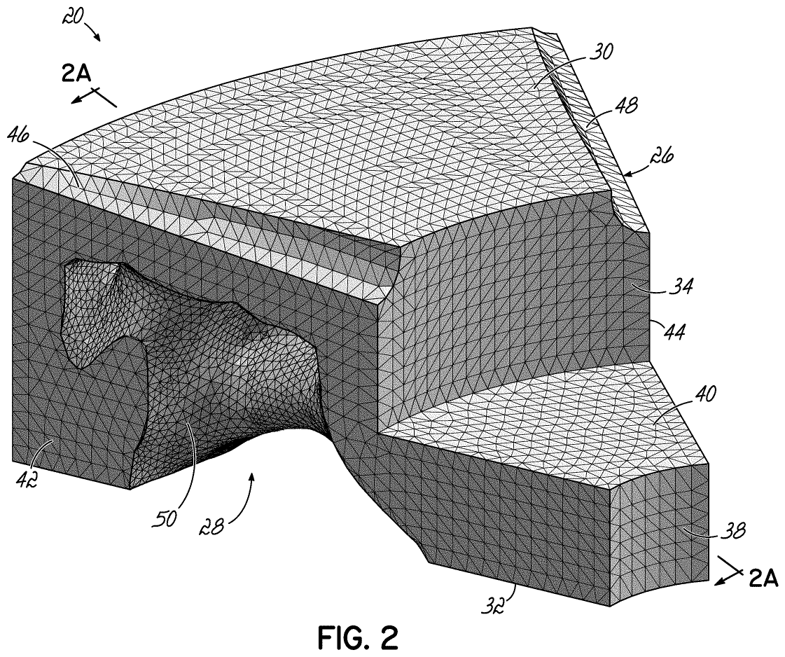

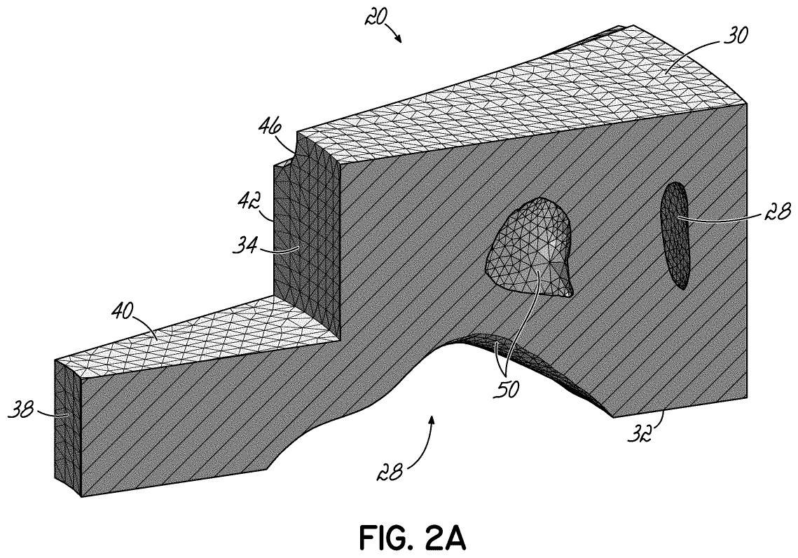

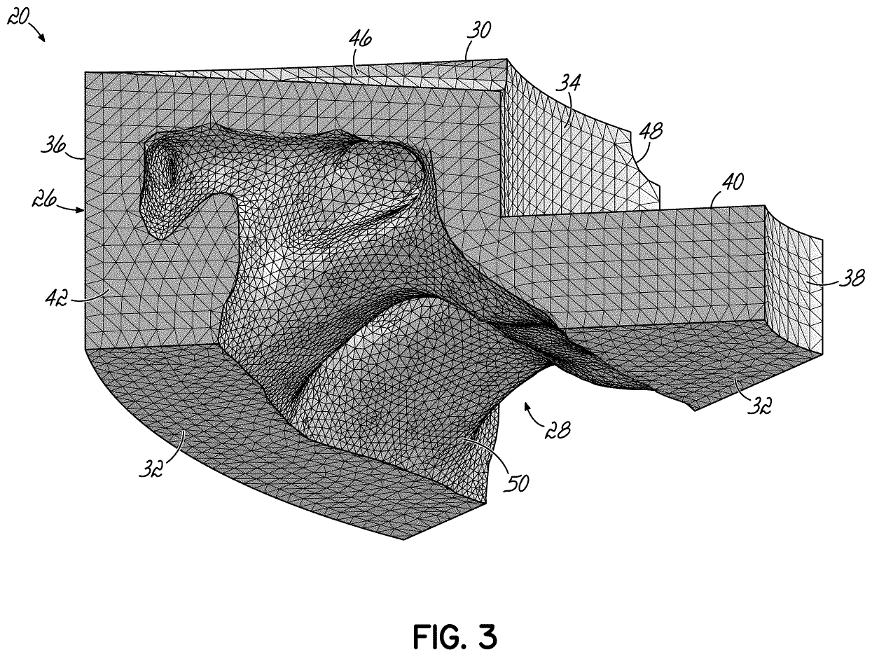

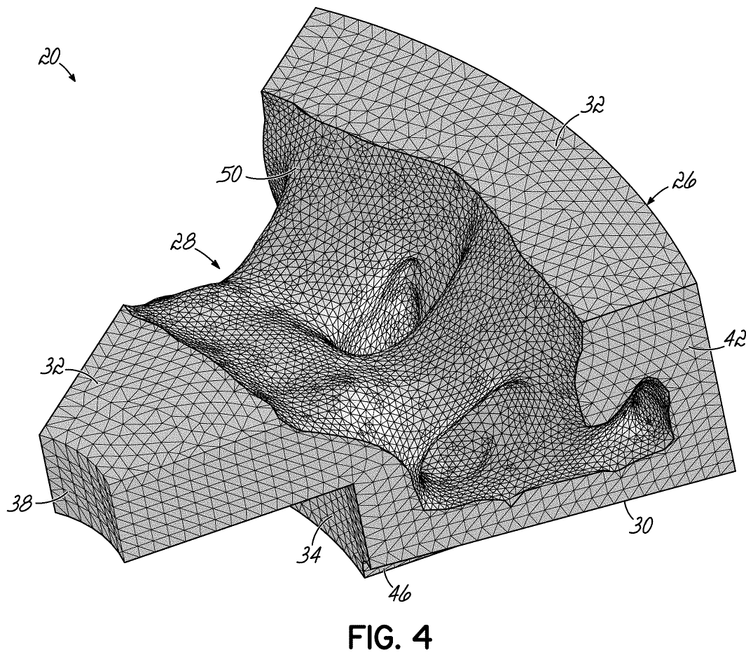

Referring now to FIGS. 2-4, a single bearing pad section or segment 20 (referred to hereafter as “bearing pad 20”) is shown in accordance with an embodiment of the present invention. A plurality of bearing pads 20 may collectively form a single bearing pad (e.g., FIG. 1A), or a single unitary bearing pad may consist of multiple sectors, each taking the form of the bearing pad segment 20 (e.g., FIG. 1). In either case, the bearing pad 20 includes a generally wedge-shaped body 26 having a bearing surface 30 that is configured to confront the thrust surface 22 of the thrust flange 16 and an opposite base surface 32 that is configured to confront the stationary surface 24 of the stationary disc 18. The bearing body 26 further includes a plurality of weight-saving voids 28 that are strategically formed externally in surfaces of the body 26, or internally embedded within the body 26, to reduce the weight of the bearing pad 20, yet not compromise the structural integrity of the bearing pad 20, as described in further detail below.

With continued reference to FIGS. 2-4, the bearing surface 30 extends between a first radially inner surface 34 and a radially outer surface 36 of the bearing pad 20. Similarly, the base surface 32 extends between a second radially inner surface 38 and the radially outer surface 36. Together, the first and second radially inner surfaces 34, 38 define a stepped portion 40 of body 26, as shown. The bearing surface 30 and the base surface 32 each extend between a first and a second sidewall 42, 44 of the body 26 of the bearing pad 20. In one embodiment, at least a portion of the base surface 32 may be fixed against movement relative to the stationary surface 24 of the stationary disc 18.

To facilitate entry of the oil between the bearing pad 20 and the thrust flange 16, the bearing pad 20 may further include a first contoured edge 46 and a second contoured edge 48. The contoured edges 46, 48 may alternatively be referred to as tapered grooves, as described in further detail below. In either case, the first contoured edge 46 extends along the intersection between the bearing surface 30 and the first sidewall 42. Similarly, the second contoured edge 48 extends along the intersection between the bearing surface 30 and the second sidewall 44. In that regard, the bearing surface 30 of each bearing pad 20 is configured to be selectively lubricated by lubricating oil and is disposed in sliding relationship with the thrust surface 22 of the thrust flange 16, as shown in FIG. 1, such that thrust loads may be effectively transmitted between the thrust flange 16 and the bearing pads 20. The hydrodynamic oil film formed between each bearing surface 30 and the thrust surface 22 may be configured to generate an oil pressure of sufficient magnitude to prevent material contact between the thrust flange 16 and the bearing pads 20 while thrust pressures are transmitted to the bearing pads 20 and, subsequently, to the stationary disc 18.

With continued reference to FIGS. 2-4, some of the plurality of weight-saving voids 28 may be formed in surfaces of the body 26 of the bearing pad 20 such that the voids 28 extend into the body 26 from the base surface 32 and the first and second sidewalls 42, 44 of the body 26. Other of the weight-saving voids 28 may be formed internally within the body 26, as shown. The plurality of voids 28 may jointly form an internal cavity or an external cavity, but this does not need to be the case. As shown, the voids 28 collectively define an organic-shaped undulating surface 50, leaving material in places where strength and stiffness is required to withstand thrust loads during operating of the bearing 10. That is, each of the plurality of voids 28 may have a unique geometry such that the organic-shaped surface 50 undulates in a non-angular natural manner across its entire area.

FIGS. 1A-1C illustrate an exemplary monolithic low-weight bearing pad (LWBP) 52 comprising of a plurality of bearing pad sections or segments 20 described above with respect to FIGS. 2-4. The LWBP 52 is in the shape of an annular disc having a bearing surface 30 that is configured to confront the thrust surface 22 of the thrust flange 16 and an opposite base surface 32 that is configured to confront the stationary surface 24 of the stationary disc 18. The LWBP 52 may comprise eight bearing pad sections 20, for example, separated by tapered grooves 54. Each tapered groove 54 is formed by a pair of corresponding contoured edges 46, 48.

As best shown in FIG. 1B, the LWBP 52 includes an external annular cavity 56 defined by the plurality of weight-saving voids 28 formed in the base surface 32 of the body 26 of the LWBP 52. In that regard, the voids 28 collectively form the external annular cavity 56 and the organic-shaped undulating surface 50, leaving material in places where strength and stiffness is required to withstand thrust loads during operating of the bearing 10. To that end, the annular cavity 56 may be formed in the bearing body 26 so as to extend from beneath the bearing surface 30 of the LWBP 52 to a non-bearing surface, such as the annular stepped portion 40 of the LWBP 52. The external annular cavity 56 may be formed as a continuous ring, a segmented ring, or non-ring shaped for example. To that end, the LWBP 52 may include several external cavities, one or more of which may be annular in shape.

Referring now to FIG. 1C, the LWBP 52 may include one or more internal annular cavities 58a, 58b defined by one or more weight-saving voids 28 formed in the body 26 of the LWBP 52. The internal annular cavities 58a, 58b are embedded within the body 26 of the LWBP 52 so as to form a hollow interior. As shown, a first internal annular cavity 58a may be formed in the body 26 of the LWBP 52 between the external annular cavity 56 and the radially outer surface 36. In the embodiment shown, another internal annular cavity 58b is formed in the stepped portion 40 of the body of the LWBP 52 between the between the external annular cavity 56 and the second radially inner surface 38. Like the external annular cavity 56, a cross-sectional area of the internal annular cavities 58a, 58b may vary about the LWBP 52 due to the undulating surfaces 50 formed by the voids 28 that define each internal annular cavities 58a, 58b. To this end, the internal annular cavities 58a, 58b may comprise a single, annular cavity, a segmented annular cavity, or a plurality of non-ring-shaped cavities.

During use, pressure developed in the oil film can far exceed load over the active surface area of the bearing 10, leading to pressures well above 1,000 psi for even lightly loaded bearings. Therefore, material strength of the body 26 of the bearing pad 20 and LWBP 52 must be strong enough to support these high pressures without experiencing significant deformation which could cause changes in the geometry of the bearing pad 20 and LWBP 52, thereby compromising performance of the bearing 10. To this end, the weight-saving voids 28 provide the bearing pad 20 and LWBP 52 with weight-saving benefits yet do not compromise the structural integrity of the bearing pad 20 and LWBP 52. Further, the configuration of the voids 28 may be optimized through the use of fluid-structure interaction numerical simulation software. As such, a hydrodynamic thrust bearing pad design may be optimized to save weight and support high loads.

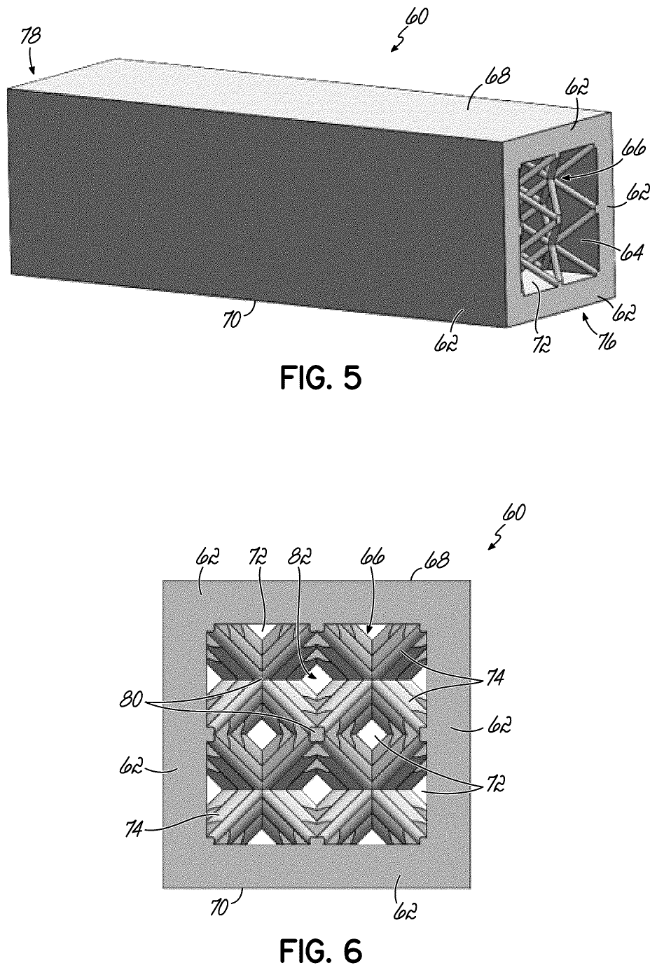

Referring now to FIGS. 5-8, a schematically simplified body section 60 of a bearing pad, such as the bearing pad 20 and LWBP 52 described above with respect to FIGS. 1-4, is shown in accordance with an embodiment of the present invention. The body section 60 may be representative of a radial or widthwise section of the body 26 of the bearing pad 20 and LWBP 52 described above with respect to FIGS. 1-4 or, alternatively, a bearing pad without the above-described weight-saving voids 28. To this end, the body section 60 may be representative of a bearing pad body 26, rather than a section of a bearing pad body 26. While the body section 60 is illustrated as being generally cuboid in shape, it will be understood that the body section 60 may take on other three-dimensional geometric shapes, such as wedge or trapezoid, for example. To this end, the drawings are not intended to be limiting.

With reference to FIG. 5, the body section 60 includes four sidewalls 62 that define a generally hollow interior 64 comprised of a plurality of voids between a network of webbing structures 66 integrated within the body section 60. While the network of webbing structures 66 is illustrated as being located within the interior 64 of the bearing section 60, the webbing structures 66 may alternatively be located elsewhere on a bearing pad, such as within the generally external voids 28 described above with respect to FIGS. 1-4, for example. In any event, at least one sidewall 62 of the body section 60 may define a bearing surface 68 that is configured to confront the thrust surface 22 of the thrust flange 16 and an opposite sidewall 62 may define a base surface 70 that is configured to confront the stationary surface 24 of the stationary disc 18.

The webbing structures 66 define a plurality of voids or spaces 72 between web members 74 of the webbing structures 66 which results in the generally hollow interior 64 of the body section 60. In that regard, the webbing structures 66 are strategically formed in the body section 60 to reduce the weight of the bearing pad, yet not compromise the structural integrity of the bearing pad. To this end, the webbing structures 66 have proved, through simulation, to provide the structural stiffness required to support high hydrodynamic pressures (e.g., 1000 psi or more) without deforming to the point of effecting the bearing performance. As described in further detail below, the webbing structures 66 provide a functional part of the bearing design as well.

Referring now to FIGS. 5-7, the body section 60 extends a length between a first end 76 and an opposite second end 78. In particular, the sidewalls 62 each extend between the first end 76 and the second end 78 of the body section 60. Although not shown, the first end 76 and the second end 78 may be closed to enclose the interior 64 of the body section 60. The network of webbing structures 66 extends between the first end 76 and the second end 78 for the full length of the body section 60. In particular, the network of webbing structures 66 is defined by a plurality of interconnected web members 74 that form lattice-like structures. As shown, some of the web members 74 extend from surfaces of the sidewalls 62 to nodes 80 of connected web members 74, and other web members 74 extend between nodes 80, to form a repeating pattern of lattice-like structures that is the network of webbing structures 66. In an alternative embodiment, the web members 74 may form a spaghetti-like network of randomized webbing structures.

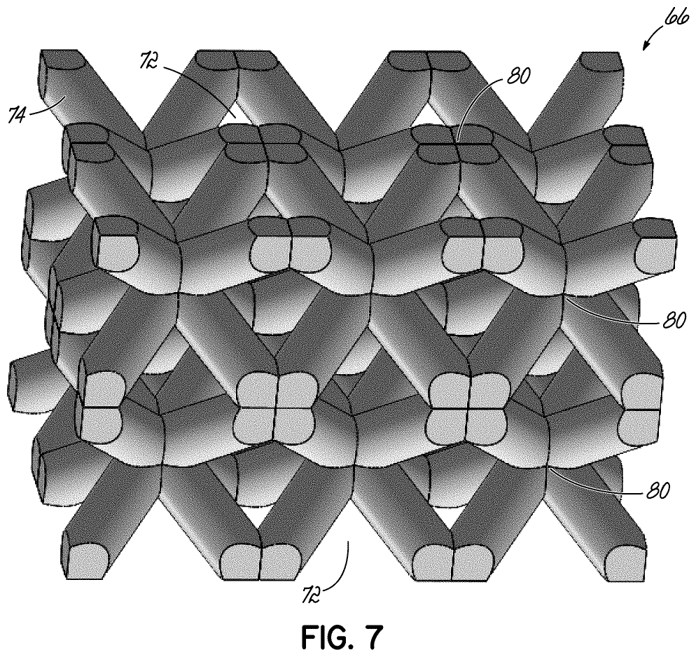

With reference to FIGS. 6 and 7, the network of webbing structures 66 forms a plurality of weight-saving voids 72 between the sidewalls 62 of the body section 60 and, in particular, between the plurality of interconnected web members 74. The repeating pattern of web members 74 may form several elongate or tunnel-like voids 82 that extend axially along the length of the body section 60 and between the first and second ends 76, 78, as shown in FIG. 6. Similarly, although not shown, the repeating pattern of web members 74 may form several elongate voids that extend perpendicular to a central axis (i.e., an axis that extends along the length of the body section 60) of the body section 60 and between sidewalls 62 of the body section 60.

While the network of webbing structures 66 is shown as having a specific repeating pattern of web members 74, it is understood that network of webbing structures 66 may be formed to have different geometries across the width and length of the body section 60 of the bearing pad so that bearing performance may be maintained or even improved during operation of the bearing assembly 10. For example, fewer or more web members 74 having different diameters, lengths, and/or thicknesses may be formed to change the overall geometry of the network of webbing structures 66. As described in further detail below, the network of webbing structures 66 is designed such that thermal expansion of the web members 74 expands the bearing pad and in particular the bearing surface 30, so that an optimal bearing pad geometry is created during in-service operation of the bearing assembly 10 to reduce friction or facilitate the introduction of lubricating oil between the moving surfaces in the bearing 10.

The network of webbing structures 66 may be designed and manufactured in many different configurations. In that regard, the webbing structures 66 not only reduce the weight of a bearing pad, but also act as a functional part of the bearing pad design. In particular, heat is conducted into the oil film during bearing 10 operation and is then transferred to the bearing surface of the bearing pad. The temperature rise of the bearing surface and the bearing pad effectuated by this heat transfer can be exploited through use of the network of webbing structures 66. As described in greater detail below, the network of webbing structures 66 provide the ability to selectively manipulate the particular taper or contour across the bearing surface of each bearing pad during operation of the bearing assembly 10 to both minimize friction and facilitate entry of the lubricant between the bearing surface of the bearing pad and the thrust surface 22 of the thrust flange 16. In other words, each bearing pad may be incrementally or continuously deformed or warped to various additional stressed states by applying different temperature loads to selectively adjust the profile of each bearing pad to achieve a desired configuration for minimizing friction. Ultimately, each bearing pad may be returned to an unstressed state by removing the applied thermal load, such as by halting operation of the bearing assembly 10.

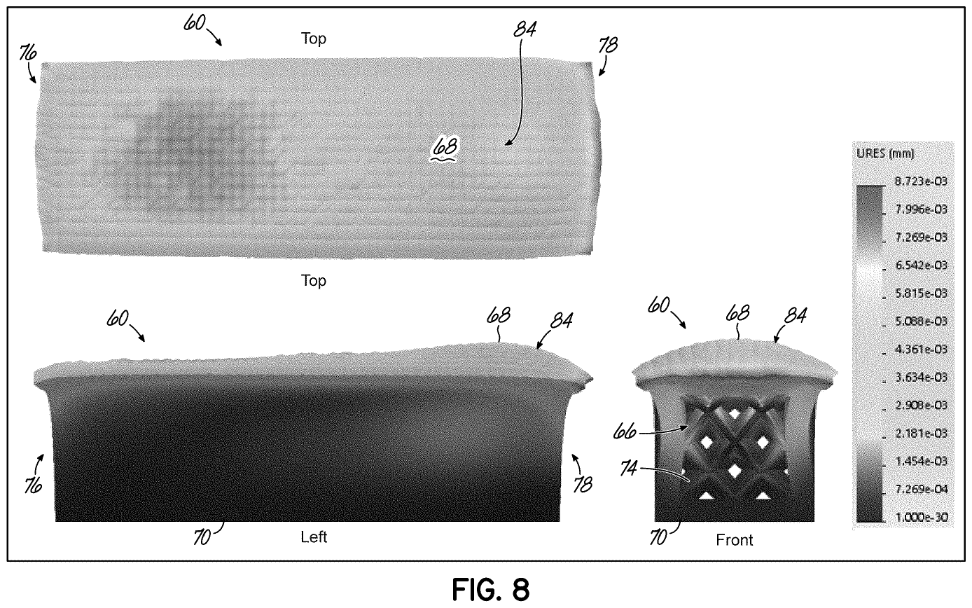

FIG. 8 illustrates the simulation results of a fluid-structure interaction numerical simulation software analysis of the above-described body section 60 of a bearing pad. In particular, a temperature boundary condition of 100° C. was applied to the bearing surface 68 of the bearing section to simulate a standard operating temperature experienced by a bearing pad. The base surface 70 of the body section 60 was fixed for the simulation. The simulation results show an oil film promoting taper 84 being formed along the bearing surface 68 due to thermal expansion of the network of webbing structures 66 within the body section 60 of the bearing pad. As shown, bearing surface 68 expands outwardly a greater extent at the second end 78 of the body section 60 compared to the first end 76 to form the taper 84 along the length of the body section 60. The taper may also extend along the width of the body section 60, as shown. For a bearing pad formed with the network of webbing structures 66, the resultant taper may extend in either direction radially, or in either direction circumferentially, or in an angled direction across the bearing surface 68. Further, the network of webbing structures 66 may be configured such that the bearing surface 68 thermally expands or deforms to have an undulating or curved profile to accommodate bearing pad stresses particular to a certain application. To this end, the body section 60 shown in FIGS. 5-6 may be representative of a bearing pad in an undeformed or unstressed state, and the body section 60 shown in FIG. 8 may be representative of a bearing pad in a deformed or stressed state during in-service operation of the bearing assembly 10.

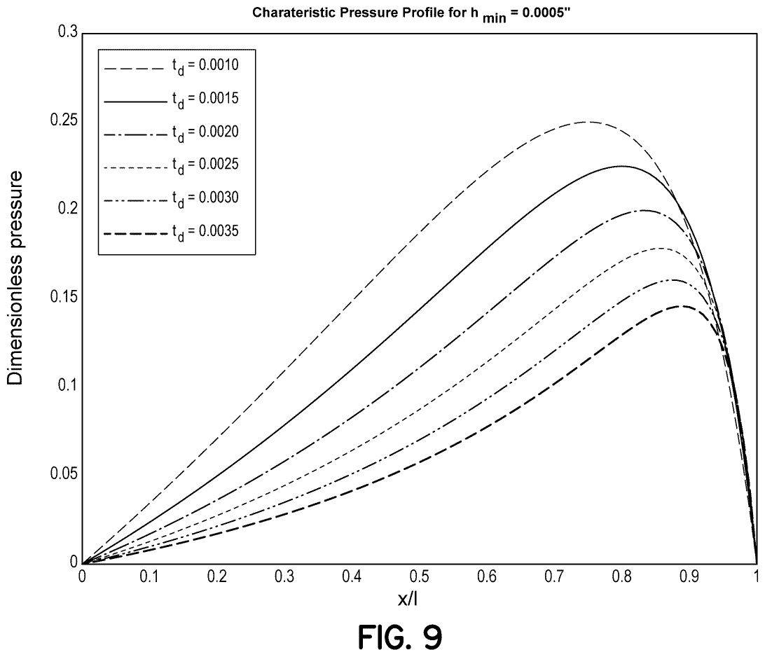

In accordance with embodiments of the present invention, the bearing pad 20 and LWBP 52 design, including the webbing structures 66, may be a product of a multi-step iterative design process involving hybridization of experimental and theoretical inputs. In particular, a database of experimental thrust bearing performance data has been captured using the Ohio University Thrust Bearing Test Rig. This data base spans variations in speed, load, oil conditions, bearing geometry and manufacturing processes. Oil film pressure distribution has been recorded at discrete locations on the thrust bearing pad surface. While this pressure data is used to suggest the overall distribution of pressure in at a fixed radial distance, it does not provide a 2-D pressure map which acts over the entire surface of the bearing pad. Existing theoretical simulation code is used to confirm the shape of these pressure distributions as a function of thrust pad taper angle, speed, load, oil temperature and viscosity, as well as minimum oil film thickness. A sample of the results are shown in FIG. 9.

While MATLAB computer simulation code may be used to generate characteristic pressure distribution profiles for the 1-D circumferential direction of a bearing surface, as shown in FIG. 9, MATLAB computer simulation code may be expanded to 2-D discrete numerical simulation to create a pressure map acting on the entire bearing surface in both the circumferential and radial directions, thereby satisfying a more realistic analysis by incorporating the real pressure boundary conditions that exist on all edges of the bearing pad. This more advanced simulation may be tweaked and adjusted until the experimental results are matched by the numerical results at the discrete physical locations where pressure is measured. Once the experimental and numerical results overlap, the corresponding numerical 2-D pressure map is taken to be the accurate load case acting on the bearing. This pressure map is then imported into SolidWorks CAD software and applied to the computer model and topology optimization is performed. SolidWorks then provides suggestions where material can be removed from the bearing pad to save weight while maintaining sufficient structural stiffness of the bearing. The material removal suggestions are considered to help guide and define an initial structural bearing design.

Furthermore, the topology optimization design is then fed back into the MATLAB program which iteratively changes both the structural load-bearing body of the bearing pad and converges on the optimal bearing surface taper geometry for the bearing pad. The novel iterative optimization process is driven by feedback retrieved from the experimental database. The result is a totally unique, computer designed bearing surface and bearing structure tailored for any given application. With significant weight savings and optimal bearing surface geometry, the efficiency of the given application is increased. Further, the unique geometry reflects a model which is best realized using additive manufacturing, as described above, as the shape may resemble somewhat amorphous/organic/potentially spaghetti-like substructure which is not possible to manufacture using subtractive methods.

Turning now to FIG. 10, a bearing pad 100 is shown in accordance with another embodiment of the present invention. The bearing pad 100, otherwise referred to as a low-weight flex pad bearing (LWFPB) 100, is in the shape of an annular disc having a bearing surface 102 that is configured to confront the thrust surface 22 of the thrust flange 16 and an opposite base surface 104 that is configured to confront the stationary surface 24 of the stationary disc 18. The LWFPB 100 comprises a plurality of bearing pad sections 106, such as eight, for example, separated by tapered grooves 108. Each bearing pad section 106 includes a void in the form of a deflection gap 110 that extends in a radial direction through the bearing pad section 106. The deflection gap 110 is strategically shaped and positioned to reduce the weight of the bearing pad section 106, yet not compromise the structural integrity of the bearing pad section 106. The shape and location of the deflection gaps 110 may be the result of the iterative design process described above. Each deflection gap 110 also provides a functional part of the bearing design, as described in further detail below.

Turning now with reference to FIGS. 11-13, an exemplary bearing pad section (referred to hereafter as “bearing pad 106”) is illustrated. The bearing pad 106 includes a generally wedge-shaped body 112 that defines a portion of the bearing surface 102 and a portion of the base surface 104 of the LWFPB 100. The bearing surface 102 extends between a first radially inner surface 114 and a radially outer surface 116 of the bearing pad 106. Similarly, the base surface 104 extends between a second radially inner surface 118 and the outer surface 116. Together, the first and second radially inner surfaces 114, 118 define a stepped portion 120 of body 112, as shown. The bearing surface 102 and the base surface 104 each extend between a first and a second sidewall 122, 124 of the body 112 of the bearing pad 106. In one embodiment, at least a portion of the base surface 104 may be fixed against movement relative to the stationary surface 24 of the stationary disc 18.

To facilitate entry of the oil between the bearing pad 106 and the thrust flange 16, the bearing pad 106 may further include a first tapered groove 108 and a second tapered groove 108. The first tapered groove 108 extends along the intersection between the bearing surface 102 and the first sidewall 42. Similarly, the second tapered groove 108 extends along the intersection between the bearing surface 102 and the second sidewall 44. As described above, the bearing surface 102 of each bearing pad 106 is configured to be selectively lubricated by lubricating oil and is disposed in sliding relationship with the thrust surface 22 of the thrust flange 16, as shown in FIG. 1, such that thrust loads may be effectively transmitted between the thrust flange 16 and the bearing pads 106. The hydrodynamic oil film formed between each bearing surface 102 and the thrust surface 22 may be configured to generate an oil pressure of sufficient magnitude to prevent material contact between the thrust flange 16 and the bearing pads 106 while thrust pressures are transmitted to the bearing pads 106 and, subsequently, to the stationary disc 18.

With continued reference to FIGS. 11-13, the bearing surface 102 of the bearing pad 106 features a gradual outward taper where the bearing surface 102 slopes downwardly in a direction from the first radially inner surface 114 (i.e., downward toward the base surface 104) to the radially outer surface 116. In that regard, the initial taper depth of the bearing surface 102, being a distance between the bearing surface 102 and the thrust flange 16 at the radially outer surface 116 of the bearing pad 106, is approximately 0.0025 inches. As a result, each tapered groove 108 may gradually widen as it extends from the radially outer surface 116 to the first radially inner surface 114 of the bearing pad 106 where each tapered groove 108 is at its maximum width. The outward taper of the bearing surface 102 in combination with the tapered grooves 108 encourages the formation of a hydrodynamic film of lubricating fluid between the bearing pad 106 and the thrust flange 16.

With continued reference to FIGS. 11-13, the deflection gap 110 extends a length from a first opening 126 formed in the first radially inner surface 114 of the bearing pad 106 to a second opening 128 formed in the radially outer surface 116 to define a passageway or void through the bearing pad 106. As shown, the deflection gap 110 extends beneath the bearing surface 102 of the bearing pad 106, and generally beneath a center region 130 of the bearing surface 102. In particular, the deflection gap 110 is generally D-shaped in transverse cross-section and includes an arcuate top wall 132 that extends beneath the bearing surface 102. The arcuate top wall 132 of the deflection gap 110 is curved (i.e., concave) in a direction generally perpendicular to the length of the deflection gap 110. As a result, a thickness of the bearing surface 102 is generally thinnest along the central region 130 of the bearing surface 102 and thickest adjacent to the sidewalls 122, 124 and tapered grooves 108. To this end, other transverse cross-sectional shapes of the deflection gap 110 are possible, such as oval, circular, rectangular, trapezoidal, or square, for example. In one embodiment, each bearing pad 106 may include a plurality of deflection gaps 110.

The deflection gaps 110 provide the LWFPB 100 with several advantages over conventional bearing pads (e.g., cast bearing pads), with the first being a reduction in material weight. In that regard, the illustrated LWFPB 100 may have a mass of approximately 90.28 grams where a conventional cast bearing pad of the same dimensions, without the deflection gaps 110, would have a mass of approximately 108.71 grams. Thus, the LWFPB 100 is approximately 17% lighter compared to a conventional cast bearing pad of the same size. The second advantage is that the deflection gaps 110 provide each bearing pad section 106 with an adjustable taper geometry when exposed to a heat load. In that regard, each deflection gap 110 promotes displacement of the tapered bearing surface 102 during applied loading. Finally, the LWFPB 100 is bi-directional, meaning that the LWFPB 100 may operate in equipment that have both clockwise and counterclockwise rotation.

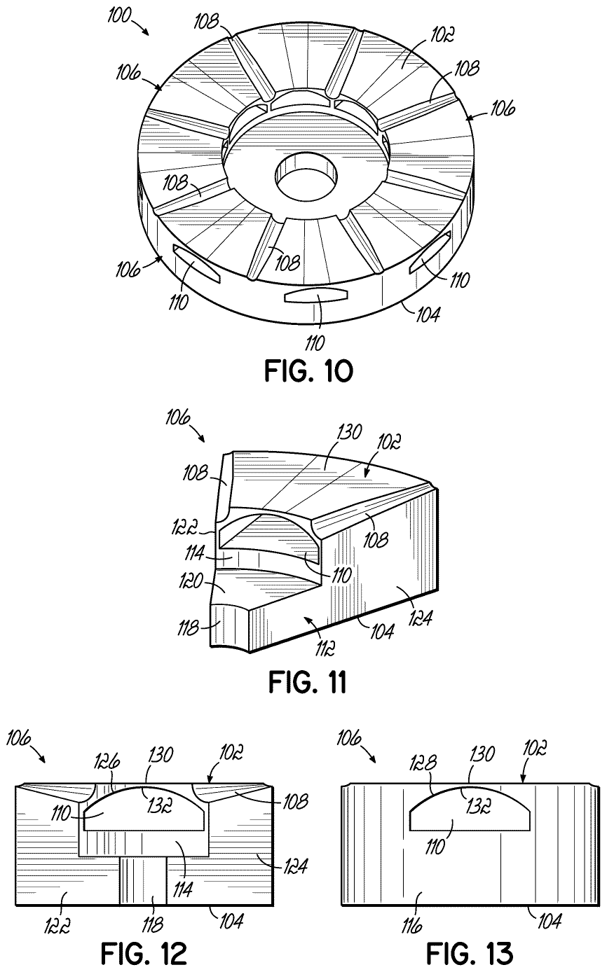

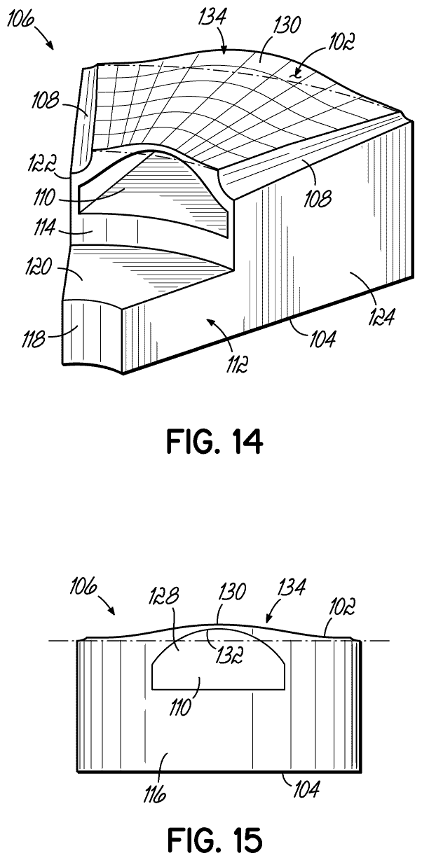

The details of an experiment conducted to test the effects of the deflection gap 110 on the taper geometry of the bearing surface 102 of the bearing pad 106 are described below and with reference to FIGS. 14 and 15. The base surface 104 of the bearing pad 106 was fixed during the simulation. The bearing surface 102 was sectioned to simulate clockwise rotation of the running surface in contact with the taper geometry. Pressures ranging from 50 psi to 500 psi were applied to the bearing surface 102 of the bearing pad 106 to simulate typical pressure magnitudes observed.

FIG. 14 shows the bearing pad 106 with the deflection contours resulting from the simulation. As shown, a schematically simplified thermally induced taper or contour 134 across the bearing surface 102 is formed as a result of the load applied. The schematically simplified thermally induced taper 134 extends generally along the center region 130 of the bearing surface 102. A peak (i.e., highest point) of the thermally induced taper 134 is centered over the arcuate atop wall 132 of the deflection gap 110. In that regard, the results show that the bearing pad 106 demonstrated a total of 0.001 inches of adjustable taper depth during operation, resulting in an initial taper depth of about 0.0015 inches after the load was applied. The initial taper depth without load is about 0.0025 inches, as described above. When compared to conventional cast bearing pads, the test observations include the following findings across the tested conditions set forth in Table 1:(1) the LWFPB 100 generates significantly higher peak pressures, (2) the LWFPB 100 produces higher minimum oil fil thickness (MOFT) values, (3) the LWFPB 100 operates at a lower temperature, and (4) the LWFPB 100 rejects a greater heat load to the lubricating oil in most cases.

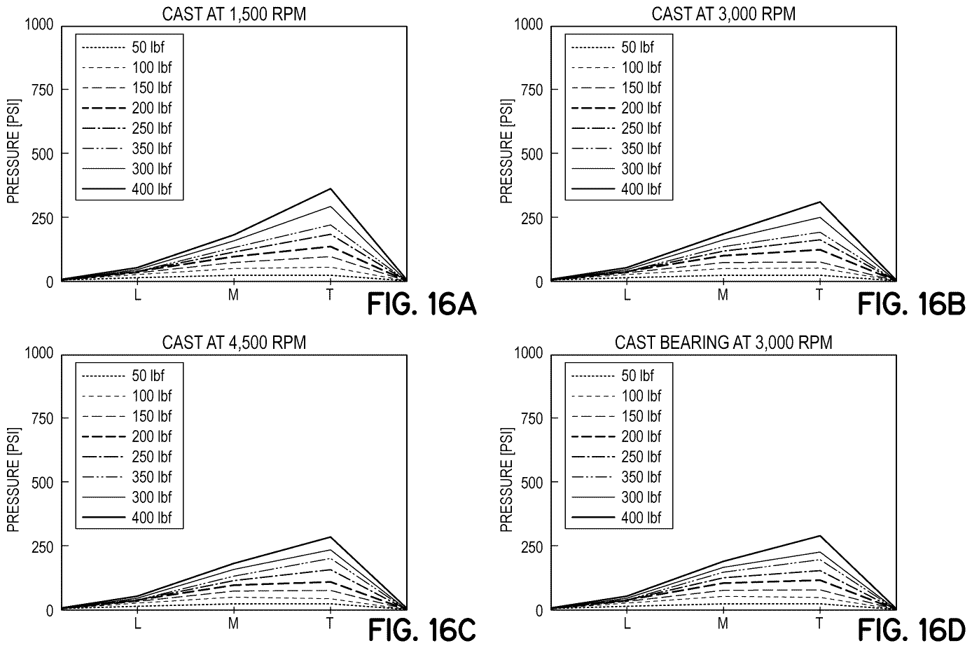

The details of an experiment conducted to test how weight-saving design features, such as the deflection gaps 110, in a fixed-geometry hydrodynamic thrust bearing affect the characteristic performance of the bearing as compared to a traditionally manufactured cast thrust bearing of identical surface geometry presented below and with reference to FIGS. 16A-22I. Two bearing samples were subjected to a test matrix consisting of various operating conditions and the critical performance characteristics, being minimum oil film thickness [MOFT], pressure distribution, bearing operating temperature, and increase in oil temperature, were measured. The first bearing sample is the control sample-a cast alloy (Cast) traditionally manufactured full-weight fixed geometry hydrodynamic thrust bearing. The second bearing is the low-weight alloy bearing (LWAB). This bearing represents a preliminary design of the LWAB intended to illustrate the unique performance capabilities. The LWAB bearing may be shaped like the bearing pad 110 described above with respect to FIG. 10. Operating conditions for the test are summarized in the table below:

TABLE 1
Test Matrix for Cast vs. LWAB bearings

| | |
|---|---|
| Thrust Loads (psi) | 100; 150; 200; 250; 300; 350; 400 |
| Rotational Speeds (rpm) | 1500; 3000; 4500; 6000 |
| Oil Type | ISO VG 32 |
| Oil Temperatures (° F.) | 86; 104; 122 |

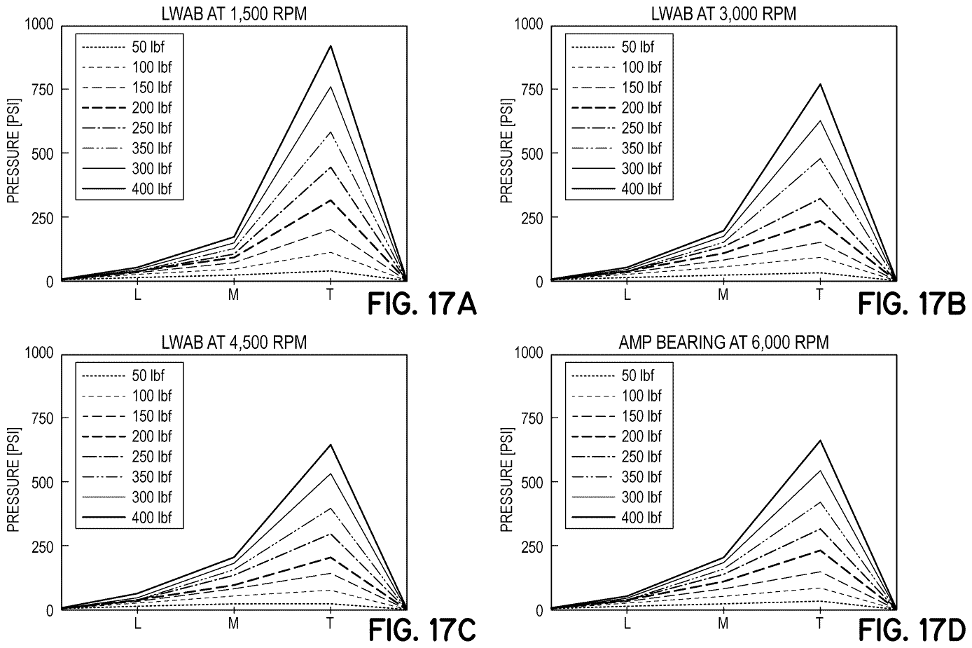

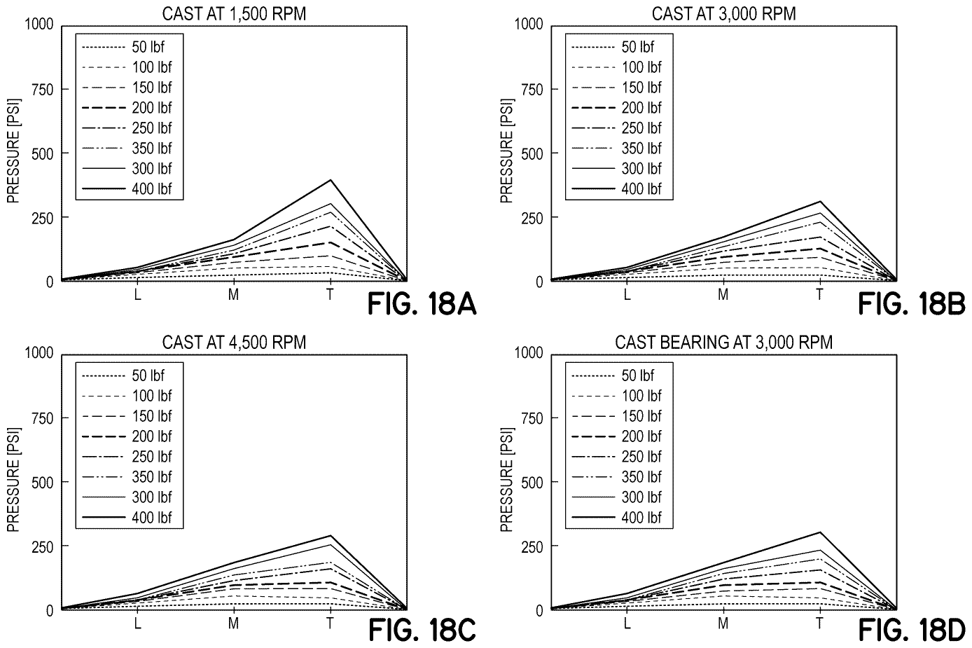

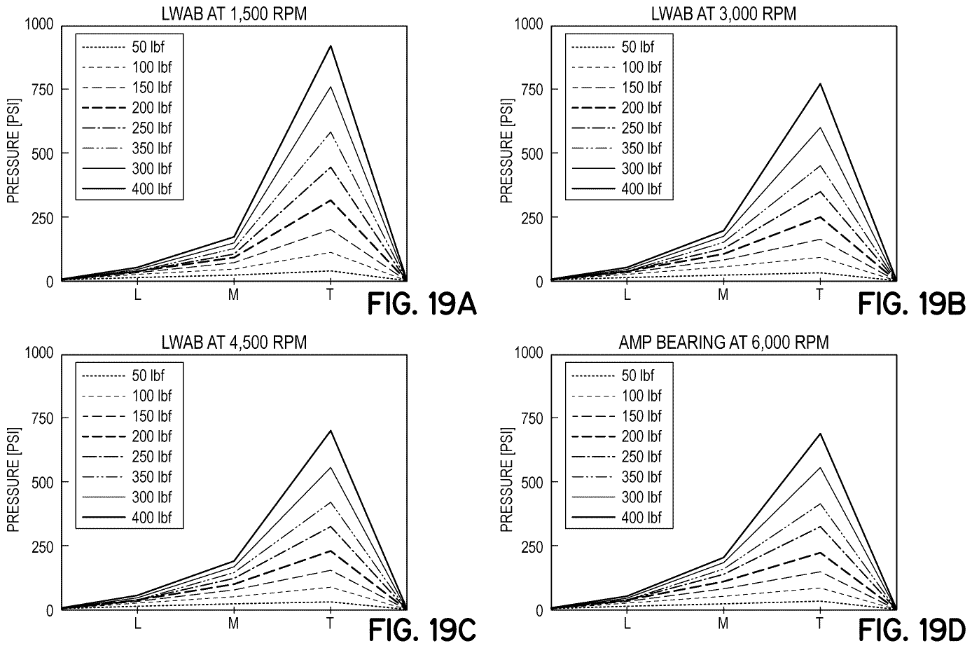

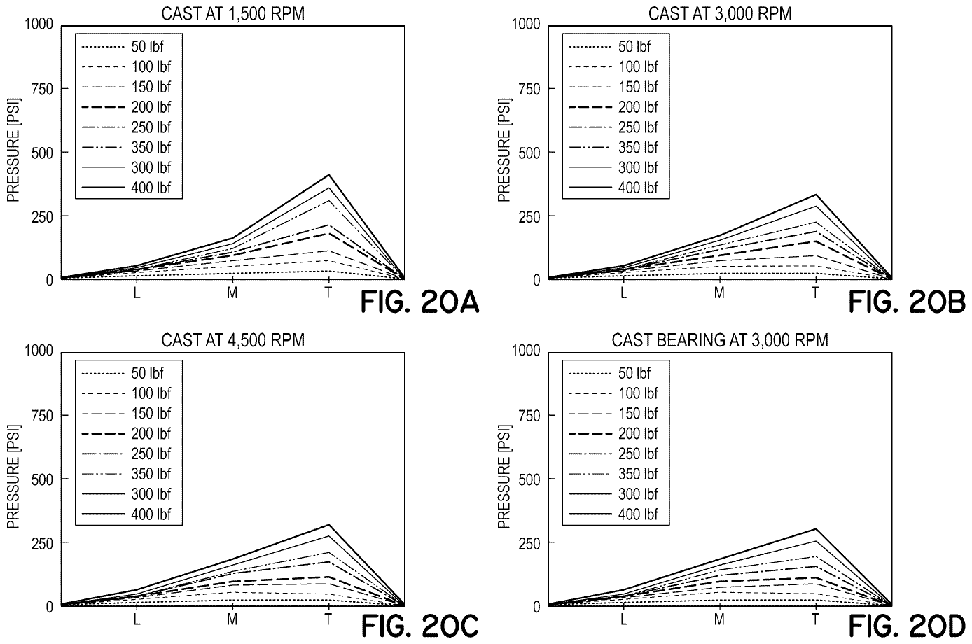

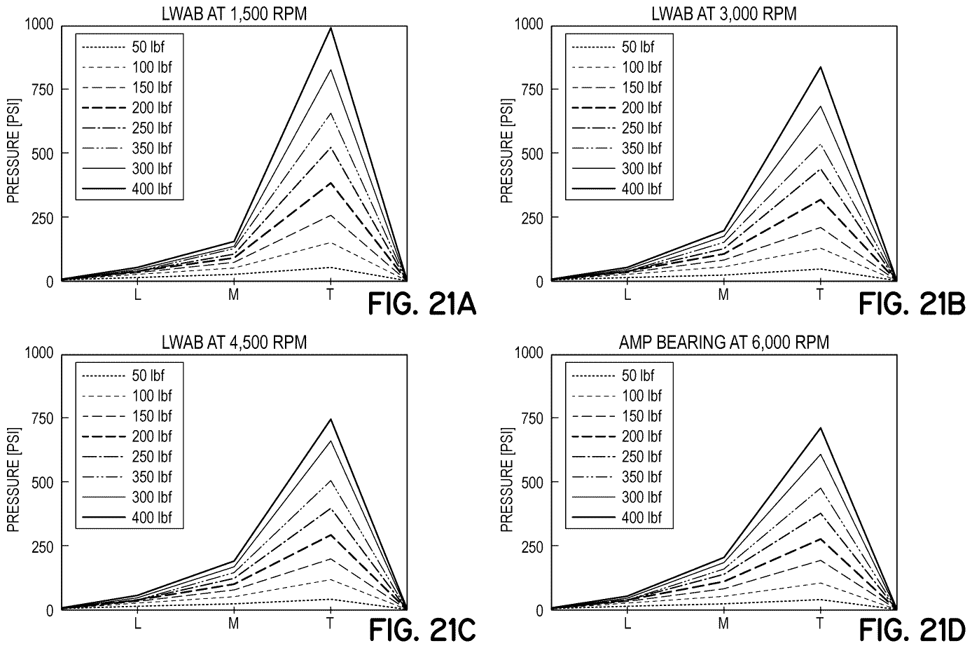

The results from this preliminary study include a comparison of pressure distribution development as load is applied for the various speeds and inlet oil temperatures at the leading (L), middle (M), and trailing (T) edges of the thrust pad surface. This comparison is illustrated graphically in FIGS. 16A-21D. In particular, compare FIGS. 16A-16D, which are graphic representations of pressure distribution development over the bearing surface of a cast bearing pad at various rotational speeds with a 30° C. inlet oil temperature, to FIGS. 17A-17D, which are graphic representations of pressure distribution development over the bearing surface of the LWAB at various rotational speeds with a 30° C. inlet oil temperature. Compare FIGS. 18A-18D, which are graphic representations of pressure distribution development over the bearing surface of a cast bearing pad at various rotational speeds with a 40° C. inlet oil temperature, to FIGS. 19A-19D, which are graphic representations of pressure distribution development over the bearing surface of the LWAB bearing at various rotational speeds with a 40° C. inlet oil temperature. Compare FIGS. 20A-20D, which are graphic representations of pressure distribution development over the bearing surface of a cast bearing pad at various rotational speeds with a 50° C. inlet oil temperature, to FIGS. 21A-21D, which are graphic representations of pressure distribution development over the bearing surface of the LWAB bearing at various rotational speeds with a 50° C. inlet oil temperature.

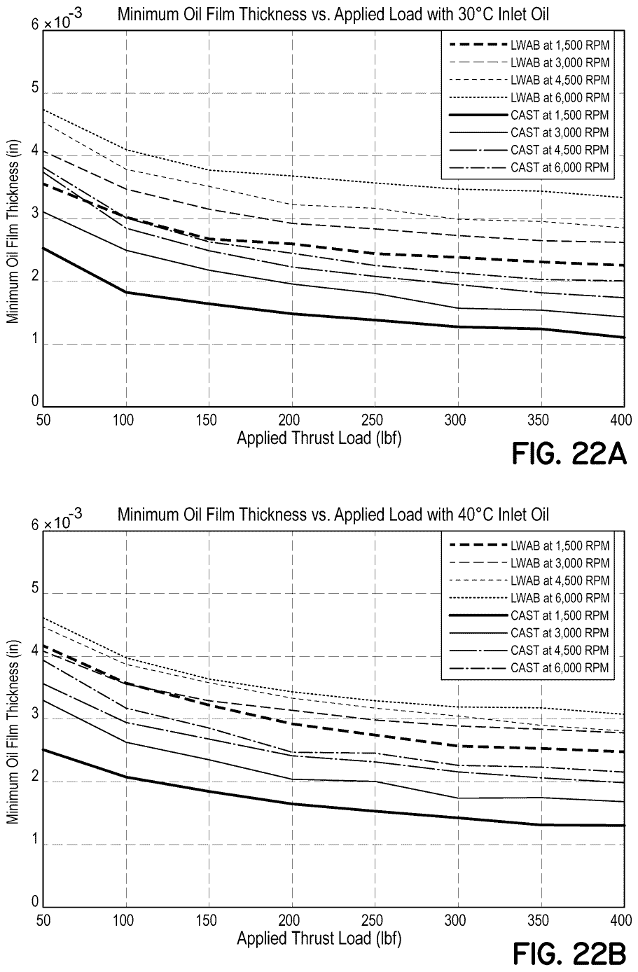

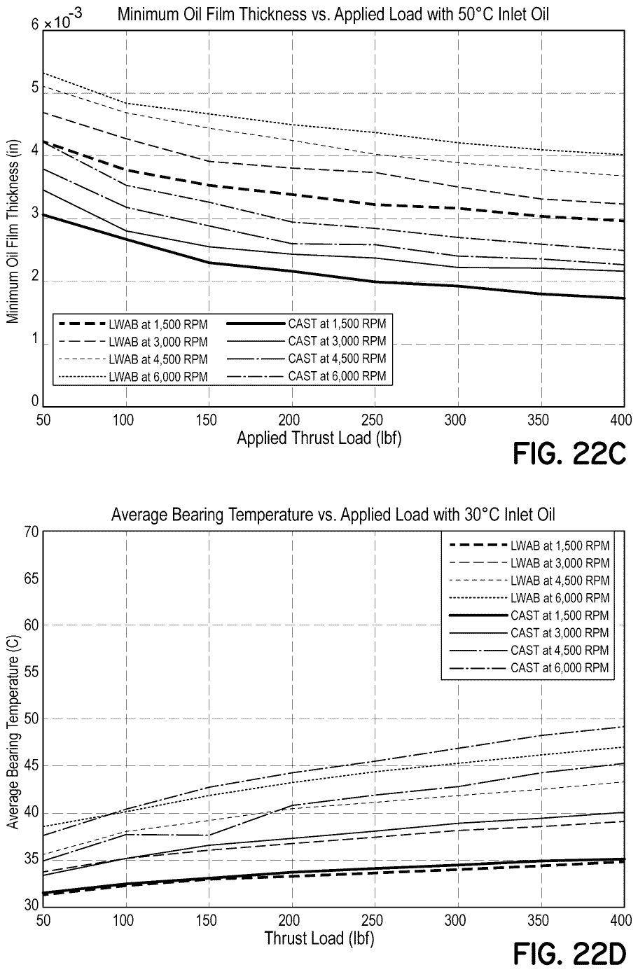

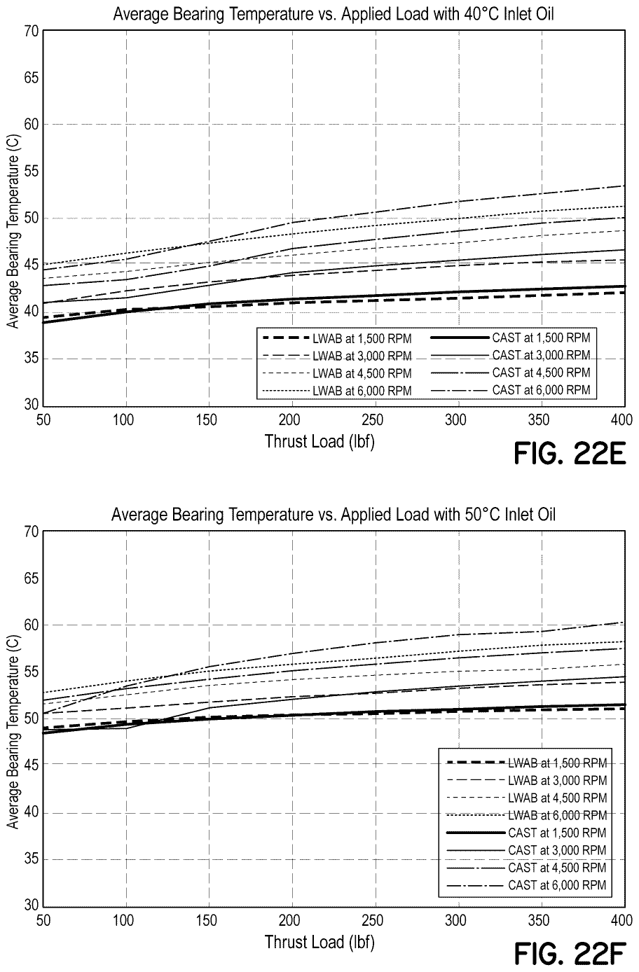

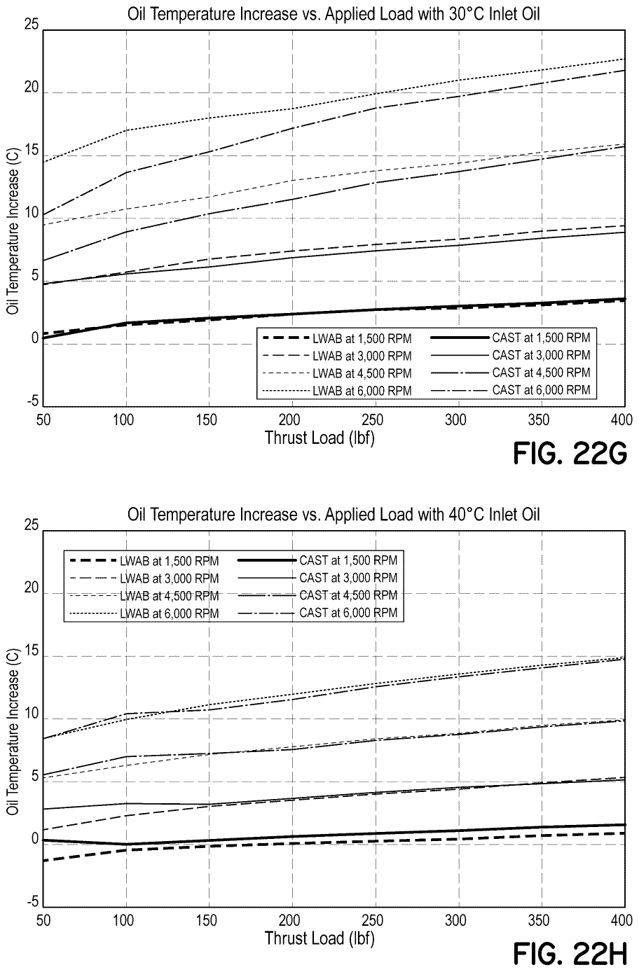

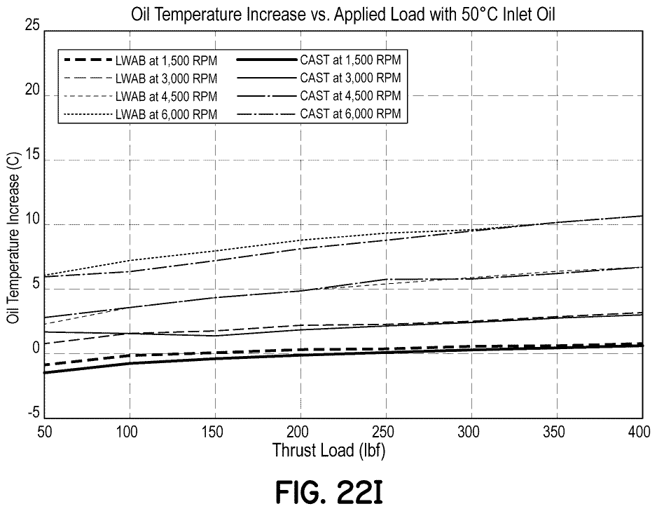

The results from this preliminary study also include a comparison of the MOFT as load is applied for the various speeds and inlet oil temperatures. This comparison is illustrated graphically in FIGS. 22A-22C.

The results from this preliminary study also include a comparison of bearing operating temperature as load is applied for the various speeds and inlet oil temperatures. This comparison is illustrated graphically in FIGS. 22D-22F.

The results from this preliminary study also include a comparison of oil temperature increase as load is applied for the various speeds and inlet oil temperatures. This comparison is illustrated graphically in FIGS. 22G-22I.

According to another embodiment of the invention, the bearing pad 20, 100/106 or portions of a bearing pad, including the network of webbing structures 66, for example, may be formed using an additive or three-dimensional (3D) printing manufacturing method. In that regard, traditional subtractive manufacturing methods are unable to form a bearing pad with the weight-saving voids 28, 72, 110 and the network of webbing structures 66 described above. The term “three-dimensional printing” or “additive manufacturing” or “rapid prototyping” refers to a process of making a three-dimensional solid object of virtually any shape from a digital model. In that regard, 3D printing of a bearing pad is achieved using an additive process, where successive layers of material are laid down in different shapes to build the structures that form the bearing pad body 26, which may include the network of webbing structures 66. Methods of forming the bearing pad may include, selective laser melting (SLM), direct metal laser sintering (DMLS), selective laser sintering (SLS) also referred to as direct metal laser sintering (DMLS) or powder bed fusion (PBF), fused deposition modeling (FDM), and stereolithography (SLA). Further, any type of 3D printing machine that can print materials suitable for bearing pads, such as metals including aluminum, for example, may be used to form the bearing pad 20, 106.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1. A hydrodynamic thrust bearing pad for use with a hydrodynamic thrust bearing assembly, comprising:
a bearing body including a bearing surface and an opposite base surface, the bearing surface being configured to confront a thrust flange of the hydrodynamic thrust bearing assembly and the base surface being configured to confront a stationary disc of the hydrodynamic thrust bearing assembly; and
at least one weight-reducing void formed in the bearing body.

2. The hydrodynamic thrust bearing pad of claim 1, wherein the at least one weight-reducing void includes a plurality of voids that extend into the bearing body from the base surface.

3. The hydrodynamic thrust bearing pad of claim 1, wherein the at least one weight-reducing void includes a plurality of voids embedded within the bearing body to define a hollow interior of the bearing body.

4. The hydrodynamic thrust bearing pad of claim 2, wherein the plurality of voids define an organic-shaped surface.

5. The hydrodynamic thrust bearing pad of claim 4, wherein the organic-shaped surface undulates.

6. The hydrodynamic thrust bearing pad of claim 2, wherein the plurality of voids jointly form a cavity in the bearing body.

7. The hydrodynamic thrust bearing pad of claim 6, wherein the cavity is an annular cavity.

8. The hydrodynamic thrust bearing pad of claim 3, wherein the hollow interior includes a network of webbing structures.

9. The hydrodynamic thrust bearing pad of claim 8, wherein the network of webbing structures comprises a plurality of interconnected web members.

10. The hydrodynamic thrust bearing pad of claim 8, wherein the network of webbing structures is configured to temporarily deform when subjected to heat to form a contour along the bearing surface of the bearing body.

11. The hydrodynamic thrust bearing pad of claim 10, wherein the network of webbing structures thermally expand to form the contour along the bearing surface of the bearing body.

12. The hydrodynamic thrust bearing pad of claim 10, wherein the contour is a gradual taper along the bearing surface of the bearing body.

13. The hydrodynamic thrust bearing pad of claim 1, wherein the at least one weight-reducing void is a deflection gap that extends beneath a center region of the bearing surface of the bearing body.

14. The hydrodynamic thrust bearing pad of claim 13, wherein the deflection gap extends a length from a first opening formed in a first radially inner surface of the bearing body to a second opening formed in a radially outer surface of the bearing body.

15. The hydrodynamic thrust bearing pad of claim 14, wherein the deflection gap includes an arcuate top wall that is curved in a direction generally perpendicular to the length of the deflection gap.

16. A hydrodynamic thrust bearing assembly, comprising:
a rotatable shaft;
a thrust surface fixedly coupled to the rotatable shaft for rotation therewith;
a stationary surface spaced apart from the thrust surface; and
one or more hydrodynamic thrust bearing pads according to claim 1.

17. A method of forming a hydrodynamic thrust bearing pad for use with a hydrodynamic thrust bearing assembly, comprising:
providing a computer model design of a first hydrodynamic thrust bearing pad design in a modeling software;
generating a pressure map across a bearing surface of the first hydrodynamic thrust bearing pad design;
applying the pressure map to the first hydrodynamic thrust bearing pad design in the modeling software;
optimizing the first hydrodynamic thrust bearing pad design by changing a part of the body of the first hydrodynamic thrust bearing pad design to create a second hydrodynamic thrust bearing pad design in the modeling software; and
forming the hydrodynamic thrust bearing pad based on the second hydrodynamic thrust bearing pad design.

18. The method of claim 17, wherein the pressure map is generated based on a database of experimental thrust bearing performance data.

19. The method of claim 17, wherein changing a part of the body of the first hydrodynamic thrust bearing pad design comprises removing material from the body.

20. The method of claim 17, wherein optimizing the first hydrodynamic thrust bearing pad design is based on maintaining a structural stiffness of the hydrodynamic thrust bearing pad.

21. The method of claim 17, further comprising forming the hydrodynamic thrust bearing pad using additive manufacturing processes.
